(19) United States
(12) Patent Application Publication
(10) Pub. No.: US 2024/0083233 A1
(43) Pub. Date: Mar. 14, 2024

(54) BATTERY ELECTRIC TRACTOR AND CONSTRUCTION KIT FOR ITS CREATION

(71) Applicant: MULAG Fahrzeugwerk Heinz Wössner GmbH u. Co. KG, Oppenau (DE)

(72) Inventor: Holger Wössner, Oberkirch (DE)

(73) Assignee: MULAG Fahrzeugwerk Heinz Wössner GmbH u. Co. KG, Oppenau (DE)

(21) Appl. No.: 18/463,442

(22) Filed: Sep. 8, 2023

(30) Foreign Application Priority Data
Sep. 8, 2022 (DE) 202022105090.2

(51) Int. Cl. B60K 1/04

(52) U.S. Cl. CPC B60K 1/04; B60K 2001/0405

(57) ABSTRACT

In order to be able to accommodate the required number of battery modules (5)—specified in terms of their external dimensions—and in particular the number required by the customer, with good weight distribution, in the chassis gradations of diesel tractors, in particular of long cabs, when switching to a battery electric drive, different arrangements of the battery modules (5) at the front and in particular also at the rear in the chassis (2) are proposed according to the invention.

### I. FIELD OF APPLICATION

The invention relates to tractors such as are used, for example, on the apron of an airport or in the industrial and logistics sector for pulling trailers and other loads.

Such tractors usually have a width significantly less than the width of conventional road vehicles so that the driver's cab usually extends over the entire width of the chassis.

In this context, a distinction is made between so-called long cabs which have a chassis front section—in which the engine is housed when operating with internal combustion engines—with a front hood in front of the windshield of the driver's cab, and cabovers in which the windshield of the driver's cab is located almost directly at the front end of the chassis, i.e. without a chassis front section in front of it, wherein—when operating with an internal combustion engine—this is located behind the driver's cab in the longitudinal region of the loading area adjoining to the rear.

### (II) TECHNICAL BACKGROUND

Such tractors are offered by manufacturers not only in these two fundamentally different types but, within each type, in different-sized designs in terms of axle spacing, track width and engine power, for which manufacturers must offer different sized chassis.

In order to be able to offer such tractors with a battery-powered electric drive—in which the traction motor is an electric motor and is supplied with energy exclusively from the traction battery—the batteries, which are still very voluminous and heavy today, must be suitably accommodated in the vehicle, whereby the batteries are usually purchased from module manufacturers in the form of cuboid battery modules, the dimensions of which must be accepted by the tractor manufacturer as they are offered by the battery manufacturer due to the small quantities.

The required or desired number of battery modules should be accommodated in the chassis of the tractor, as already exists for drives with an internal combustion engine, as far as possible with a good weight distribution and a low center of gravity, without hindering cooling, maintenance and installation/replacement of the batteries.

### III. DESCRIPTION OF THE INVENTION

### a) Technical Problem

The problem according to the invention is therefore to provide an arrangement of the battery modules in the chassis of the tractor which, depending on the provided number of battery modules and the boundary conditions specified by the selected chassis, optimally meets these criteria.

The problem according to the invention is also to provide a modular system for creating the tractors in different designs and also to enable construction types from as few modular system parts as possible.

### b) Solution to the problem

This problem is solved by the features of claims 1 and 12. Advantageous embodiments result from the dependent claims.

A generic battery electric tractor typically has a chassis on which two axles—a front axle and a rear axle—with the corresponding wheels are mounted, and an electric traction motor for the traction drive and at least two battery modules which serve to supply power to this electric traction motor.

Such an axle can also be a double axle with individual axes arranged one behind the other at a short distance.

A battery module is understood to mean a module composed of a plurality of battery cells and provided with a holder, which can be handled uniformly and is offered on the market by battery manufacturers. Typically, such a battery module is a flat cuboid, therefore possessing a length, a width, and a thickness, wherein the length is preferably greater than the width, and the width is preferably greater than the thickness, and wherein the width is usually at least twice the thickness, and the length is usually at least three or even four times the thickness.

Such a typical battery module is approximately 1 m long and weighs about 300 kg.

With regard to such a generic tractor, this problem is solved according to the invention in that at least one battery module—for example, viewed in plan view—is arranged behind the rear axle position, preferably completely behind the rear axle position, while another battery module—for example viewed in plan view—is arranged in front of the rear axle position, preferably completely in front of the rear axle position.

Preferably, the battery module arranged behind the rear axle is arranged in the chassis so as to be lying on edge or standing on edge and extends with its length or width in the transverse direction of the tractor, in any case with its thickness direction running in the longitudinal direction of the tractor. As a result, only a very short projection of the chassis beyond the rear axle to the rear is required.

This is possible, among other things, in that the electric traction motor is arranged above the rear axle position of the driven rear axle, in particular the rear axle beam, i.e. in particular at most 10 cm, better at most only 5 cm, and better to not protrude at all rearward beyond the rear axle beam when in plan view.

As a result, sufficient space remains between the rear axle assembly and the rear end of the chassis for the high edge accommodation of the rear battery module.

Also, a reducing active connection that is typically available, generally a spur gear connection via toothed wheels, between the motor output shaft, which usually points in the longitudinal direction of the tractor, and the driven rear axle, in particular the differential arranged therein, in the direction of travel, is arranged in front of the rest of the rear axle, in particular the rear axle beam.

As a result, this active connection also requires no space between the rear axle position and the rear end of the chassis.

For the same reason, the inverter is preferably also arranged within the axle spacing in its rear half, especially since the electrical lines for the alternating current can thereby be kept very short from the inverter to the traction motor, which minimizes electrical losses. The electrical fuse unit and the charger can also be accommodated within the axle spacing, preferably each as low as possible.

In contrast, the resulting greater length of the DC lines from the battery modules to the inverter does not have a negative effect.

On the one hand, this results in good weight distribution, and on the other hand good space utilization within the chassis.

An axle position, such as the rear axle position, is understood to be the position in the longitudinal direction, the straight-ahead direction of travel, of the tractor at which is located—viewed from above or from the side—the common axis of rotation, i.e. the common wheel axle of the wheels of this axle in the straight-ahead driving position.

In the case of a cuboid battery, in particular a flat cuboid battery, a battery arranged on edge means that the battery stands or lies on one of its narrow sides.

Lying on edge is understood to mean that such a battery lies on its longest narrow side, standing on edge is understood to mean that such a battery stands on its shortest narrow side.

These and the following statements apply in particular to a tractor in the design of a long cab.

Preferably, the at least one front battery module extends longitudinally across one of the axle positions, in particular across the front axle position.

In this case, this battery module extending over the axle position is preferably located at least 40%, better at least 50%, better at least 60% of its extension, viewed in plan view, in the longitudinal direction in the region between the axle positions, i.e. within the so-called axle spacing.

The rest of the extent of this at least one front battery module is located outside the axle spacing, preferably when extending across the front axle position before the front axle position of the battery module.

This results in a good weight distribution and nevertheless makes it possible to install the above-described battery modules into a chassis, as has already existed for a drive by means of internal combustion engines, so that very similar chassis can be used for both types of drive.

In this case, this front battery module extending over the axle position is preferably located at a height above the axis of rotation or the hub height of the corresponding axle, in particular above an axle beam which is continuous or cranked in the transverse direction from the left wheel to the right wheel.

This enables the use of axles with a continuous or cranked axle beam in the transverse direction so that a more complex single-wheel suspension can be avoided.

If this front battery module, in particular when it extends over the axle position, even above the wheel height, i.e. the upper edge of the wheels of this axle in the vicinity of which the battery module is located, is arranged so that it can extend in the transverse direction over the wheel, in particular when the wheels are turned in, the width of the chassis can thereby be utilized particularly well.

As a result, even on tractors with a very narrow track width, the battery module can be installed flat and with its length in the transverse direction to the tractor so that a sufficient number of battery modules can be accommodated even on small tractors.

Preferably, however, a front battery module extending over the front axle position is installed with its longitudinal battery direction in the longitudinal direction of the tractor, or positioned with only a slight deviation therefrom of no more than 30°, better no more than 20°, better no more than 10°.

This allows such battery modules to be accommodated even in narrow tractors, at least lying on edge in the longitudinal direction, or also lying flat in the longitudinal direction.

However, with a sufficient width of the chassis, it can also be arranged with its battery longitudinal direction in the transverse direction of the tractor.

If at least two front battery modules, that is to say battery modules lying in front of the front axle position, are present, they are preferably installed running parallel and with their longitudinal direction in the longitudinal direction of the tractor, preferably lying flat—if the width available in the chassis is sufficient for this—or on edge, but preferably lying on edge.

In order to keep the center of gravity of the tractor as low as possible, it is advantageous if said front battery modules, in particular a plurality of said front battery modules, extend downwards to below hub height, which, however, is only possible with cranked axles or with independent wheel suspension.

With the simpler and most used design of an axle with a transversely continuous axle beam, the one or more battery modules can only be located above it.

If the width within the chassis is sufficient, then the flat-lying arrangement of the two battery modules one above the other—with space between them for cooling reasons—usually results in the lower center of gravity position of the battery modules in total; in addition, battery modules lying flat one above the other are more favorable for optimum cooling in the common designs.

However, two front battery modules can also be arranged in the longitudinal direction of the tractor one behind the other, possibly partially overlapping in the longitudinal direction of the tractor, which, depending on the dimensions of the chassis, even makes it possible to accommodate a third front battery module:

One possibility is to arrange at least two front battery modules each lying flat one behind the other in the longitudinal direction, of which preferably the one further to the rear of the two with the battery length in the transverse direction and preferably the at least one—or two one above the other—further to the front of the two with the battery length in the longitudinal direction of the tractor.

Alternatively, the battery module further to the rear of the at least two front battery modules can be installed lying on edge in the transverse direction, as close as possible to the front of the driver's cab. In front of this, another front battery module—depending on the dimensions of the chassis—can be arranged lying flat with the battery length in the longitudinal direction or in the transverse direction, or even two lying on top of each other or on edge next to each other, especially when arranged in the longitudinal direction.

As a rule, the connections, i.e. in particular the electrical connections, of the battery module are located in its shortest side, in the case of a cuboid battery module, in its short narrow side.

In the case of battery modules installed over the front-axle position, these are preferably installed with the connections to the front when the batteries are mounted in the longitudinal direction, otherwise with the connection facing sideways. In the case of a battery module standing on edge, the latter is preferably mounted with the connections pointing upwards.

The in particular front battery modules are fastened to the chassis by means of a module holder which is in particular U-shaped or L-shaped, wherein the distance between the freely ending legs of the U-shape is dimensioned such that it can receive the battery module therebetween.

Either different module holders are available for battery modules standing or lying on edge—usually only identical battery modules are installed inside the tractor—and/or the distance between the freely ending legs of the U-shape can be adjusted.

Since such a module holder has to be fastened at different locations depending on the design and size of the chassis, the module holder preferably also has different fastening devices, for example screw holes, for fastening at different locations and/or to different chassis, for example in a corresponding hole pattern which has fastening holes for different chassis.

This arrangement of battery modules is also advantageous for the cabover design of a tractor:

Since a loading area usually extends rearward from the driver's cab at about half the height of the tractor, a battery module can also be accommodated behind the rear-axle position in such a tractor, again preferably on edge, preferably lying on edge, since it is generally not possible to accommodate it standing on edge below the level of the loading area.

At least one front battery module can then be arranged in front of the rear axle position, be it in the axle spacing between the axles or also partially projecting forward over the front axle, such as partially protruding under the driver's cab, then preferably in a flat lying arrangement.

In a further embodiment of the invention, it can be provided that the connections (6), in particular the electrical connections (6), of the battery module (5) are arranged in the shortest side thereof, or in the case of a cuboid battery module (5), in the short narrow side thereof.

In a further embodiment of the invention, the battery module (5) can have liquid cooling, wherein the at least one front battery module (5.2) with the liquid connections can be arranged pointing forwards and can be connected to a liquid cooler arranged in front of the at least one battery module (5.2) in the chassis (2).

In a further embodiment of the invention, it can be provided that the battery modules (5) are fastened to the chassis (2) by means of a module holder (7.1, 7.2), or/and the module holder (7.1, 7.2) has different fastening devices, for example screw holes, for fastening to different points in the chassis (2) and/or to different components of the chassis.

In a further embodiment of the invention, it can be provided that either the module holder (7.1, 7.2) is U-shaped or L-shaped, wherein in particular the distance between the freely ending legs of the U-shape can be changed, or the module holder (7.1, 7.2) is designed angled, wherein in particular the bottom horizontally running leg in the assembled state has fastening devices for fastening relative to the chassis (2), or/and wherein in particular the module holder (7.1, 7.2) is U-shaped, wherein the distance between the freely ending legs of the U-shape is dimensioned such that a battery module, better two battery modules, fit therebetween.

In a further embodiment of the invention, it can be provided that the rear battery module (5.1) is fastened primarily standing to the chassis (2), in particular the module holder (7.1) extends horizontally along the upper side of the battery module (5.1).

If products, such as tractors, in similar designs, for example in principle the same design but different dimensions, have to be produced in greater numbers, a modular system can be used for this purpose, in which individual parts or assemblies of the tractor are kept in stock in different variants as modular parts, which means that a large variety of differently designed tractors can be produced from relatively few different modular parts, which keeps the costs for warehousing and logistics within limits.

According to the invention, this problem is solved with regard to the modular system in that a modular system comprises as modular parts:
at least one type of battery module,
at least one type of module holder,
at least one type of traction motor.

Together with different chassis or chassis assemblies, these can already be used to produce very many different variants of a battery electric tractor.

Preferably, the modular system comprises not only one but two types of module holders as modular parts, namely:
a type of module holder for fastening a battery module only lying flat to the chassis,
a type of module holder for fastening a battery module only upright, in particular lying upright, to the chassis.

The battery modules can thereby be mounted in different installation positions.

The modular system preferably comprises as modular parts:
a plurality of types of traction motors which differ in particular with regard to their continuous power,
   and/or
a plurality of types of front axles and/or rear axles which differ in particular with regard to their wheel spacing, i.e. the track width, and/or their permissible axle load.

This makes it possible to create tractors with different performances and/or different track widths in which the battery modules can be arranged differently in each case.

The modular system preferably comprises as modular parts:
at least one type, preferably a plurality of types, of chassis side parts which differ in particular with regard to their axle spacing,
at least one type, preferably a plurality of types, of chassis cross members which differ in particular with regard to their length in the transverse direction, i.e. with regard to the possible track width, and are matched in particular to the track widths of the axles provided as modular parts.

As a result, tractors of different lengths and different widths can be produced in which the battery modules can be positioned in different arrangements.

### c) Embodiments

Embodiments according to the invention are described in more detail below by way of example. In the drawings:

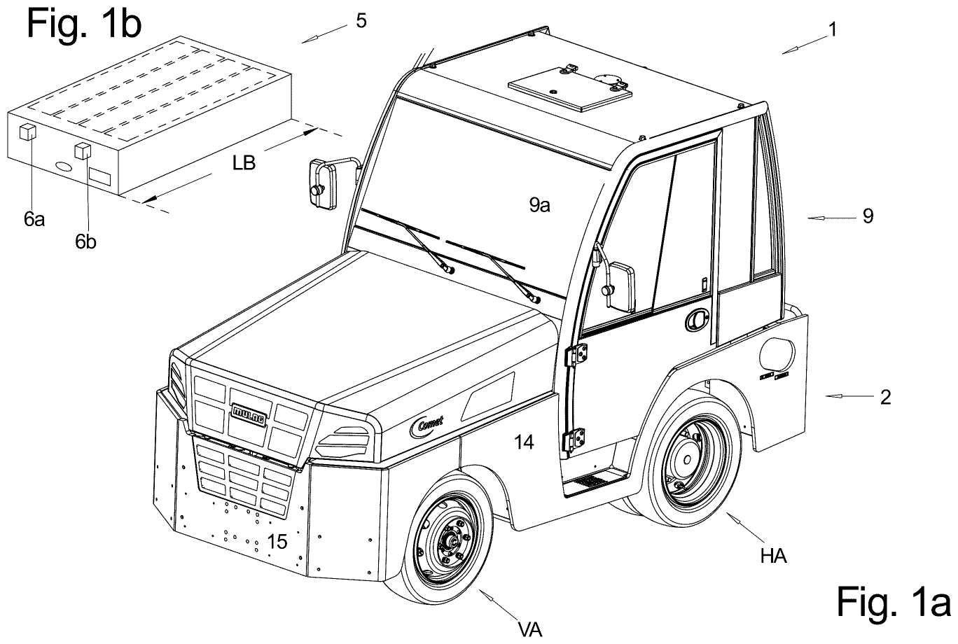

FIG. 1a: shows a perspective view of a tractor of the long cab type,

FIG. 1b: shows a perspective view of a battery module,

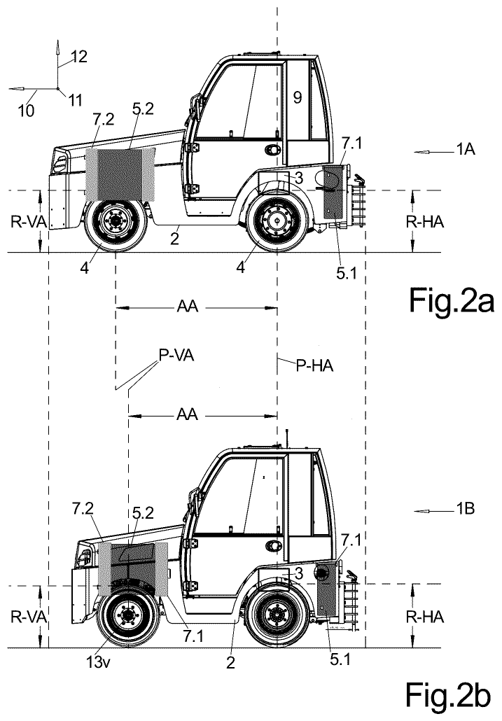

FIG. 2a, b: show a side view of two such tractors, but of different lengths,

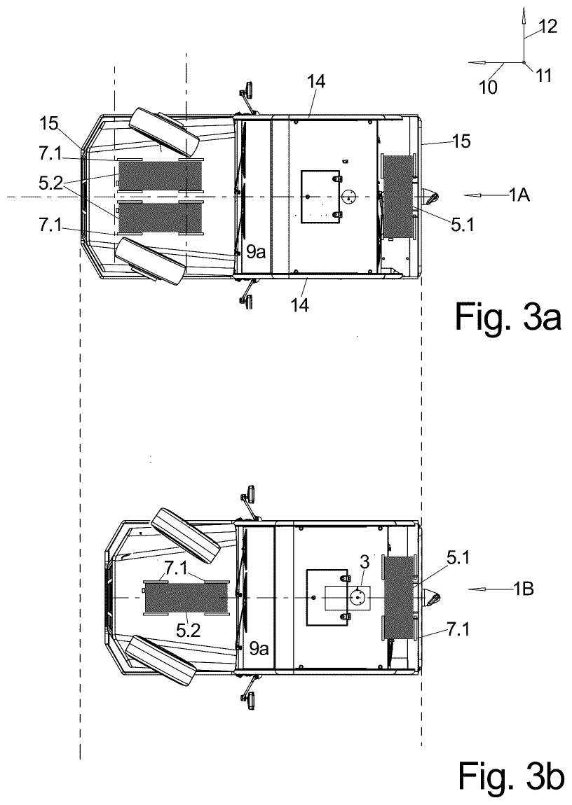

FIG. 3a, b: show a bird's-eye view of the two tractors of different lengths according to FIG. 2a, b,

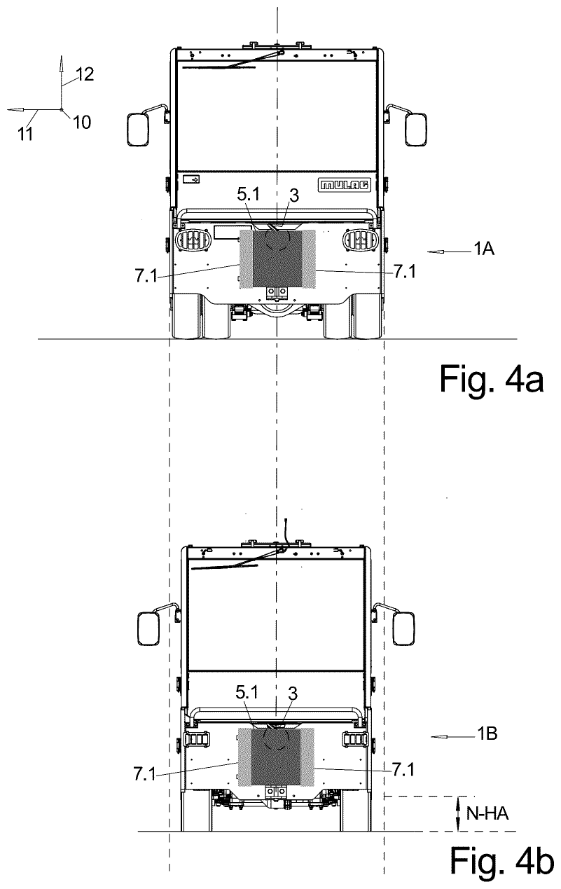

FIG. 4a, b: show a rear view of two such tractors, but of different lengths,

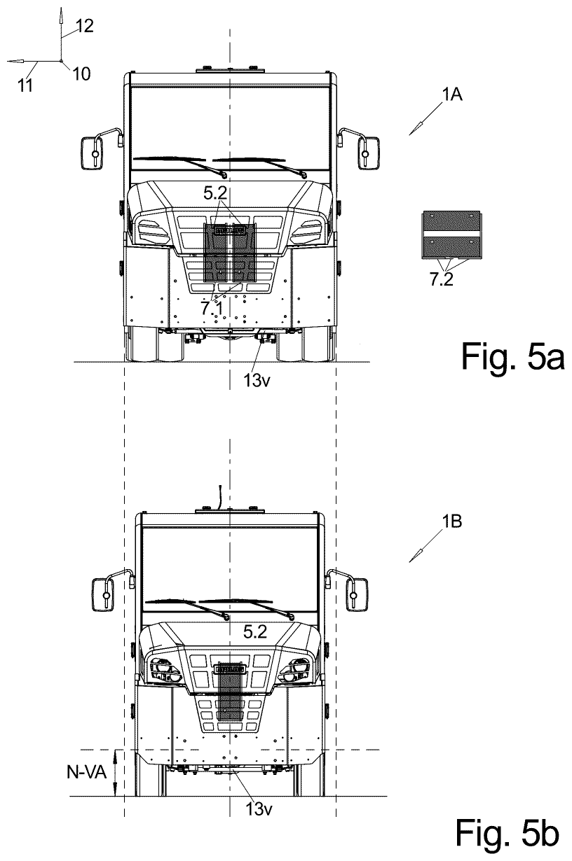

FIG. 5a, b: show a front view of the two tractors of different widths according to FIG. 4a, b,

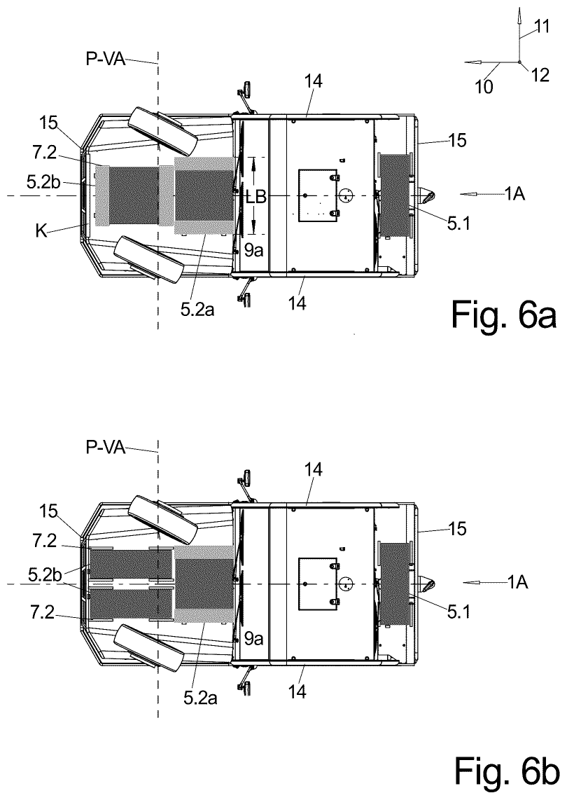

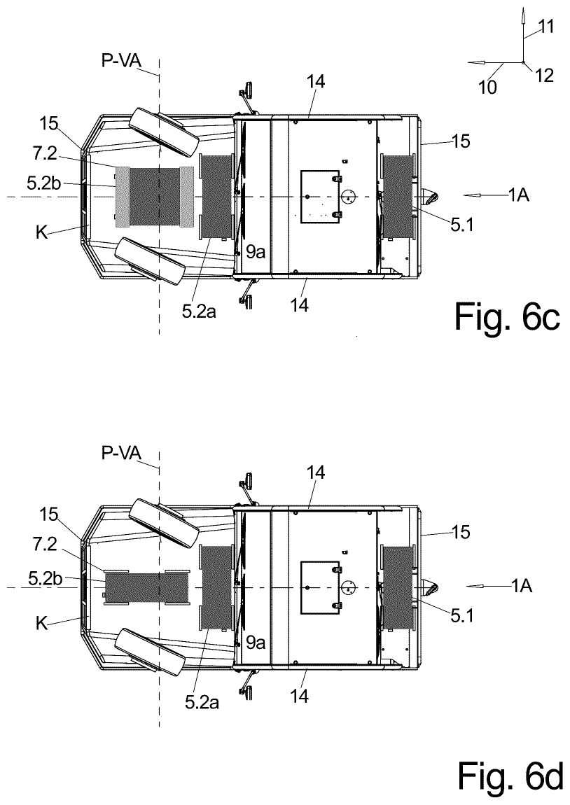

FIG. 6a-d: show different further installation variants of the front battery modules on a tractor shown only in plan view,

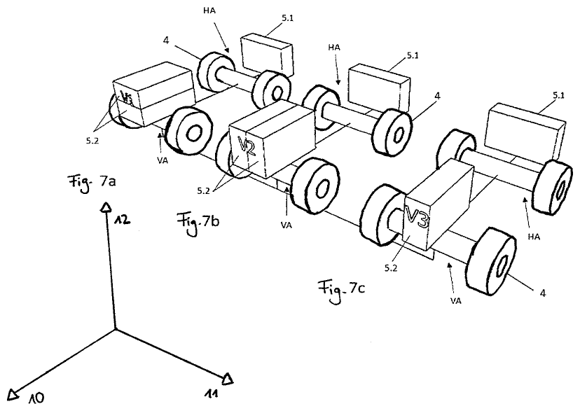

FIG. 7a-c: show a simplified view of further installation variants of the battery modules in a perspective view.

FIG. 1a shows a perspective view of a tractor in the design as a long

cab, the chassis of which thus has a long front part beyond the mounted driver's cab, but projects very little beyond the rear end of the driver's cab.

In the front part of the chassis, when driving with an internal combustion engine, said internal combustion engine is arranged under the front hood which is to be opened.

The electric motor is in this case—as best shown in FIG. 2a, 2b—above the rear axle HA.

In this case, the front axle VA is located under the front part of the chassis 2 and completely in front of the driver's cab 9, as seen in the longitudinal direction 10 of the tractor 1, while the rear axle HA is partially located under the driver's cab 9.

The rear axle can have double tires as shown in FIG. 1a, or single tires.

FIG. 1b shows a typical cuboidal battery module 5 which is approximately twice as wide and approximately four times as long as its thickness. As indicated, there are, for example, about 100 or more battery cells in several layers one above the other, which are already pre-wired in the battery module 5 and, if necessary, also equipped with liquid cooling within the battery module.

The smallest side surface, i.e. the short narrow side, of the battery module 5 accommodates its connections, in particular the two electrical connections 6a, 6b, but also, if applicable, connections for liquid cooling, and in addition, if necessary, display elements, control connections, etc. It is conceivable that the two electrical connections 6a, 6b and, if applicable, display elements and/or control connections are arranged on one of the two smallest side surfaces of the battery module 5, and the connections for the liquid cooling are arranged on the other of the two smallest side surfaces of the battery module 5. Alternatively, the two electrical connections 6a, 6b and optionally the display elements and/or control connections and the connections for the liquid cooling can be arranged on a common side surface of the two smallest side surfaces of the battery module 5.

In the following FIGS. 2a, b to 5a, b, one figure shows a tractor 1A which is longer and wider than the tractor 1B of the same tractor series shown in the other figure, and on which the different accommodations of the battery modules 5 are shown.

What they all have in common is that a first, rear battery module 5.1 is arranged on edge behind the rear axle HA in the chassis 2, with the electrical connections 6a, b pointing to the side, i.e. aligned with its battery length LB in the transverse direction 11 of the tractor 1.

As FIG. 4a, b show, this rear battery module 5.1 can be arranged very low, i.e. with its lower edge lower than the rear axle beam, for example.

As can be seen from FIG. 2a, b, the front battery module 5.2 is installed on edge in the front part of the chassis in both the longer tractor 1A and the shorter tractor 1B, extending in the longitudinal direction 10 across the front axle position P-VA, and in this case also at such a height that it extends across the front axle body 13v, which is approximately at hub height.

In this case, this front battery module 5.2 is installed lying on edge, i.e. with its battery length LB running in the longitudinal direction 10 of the tractor and with the electrical connections 6a, b pointing to the rear. In contrast, the connections for the liquid cooling can point forward in the longitudinal direction 10, i.e. in the direction of travel of the tractor.

As the plan view of FIG. 3a, b shows, however, the greater width of the tractor 1A allows two front battery modules 5.2 to be arranged in parallel side by side in the transverse direction 11, which the narrow width does not allow in the tractor 1B in which only a single front battery module 5.2 is arranged, then preferably on the longitudinal center of the chassis 2.

In the front view of FIG. 5a, 5b an alternative arrangement of the two front battery modules 5.2 lying flat and spaced one above the other is shown in addition in the wider tractor 1A, which is not possible in the narrower tractor 1B below because of the space required in the transverse direction 11 for turning the front wheels 4.

FIG. 5a, b also show that, compared to the shown installation position in which one or both front battery modules 5.2 are located with their lower edge above the hub height N-VA of the front axle and in particular also above its axle beam 13v.

A lower installation position, in which the one or the two front battery modules 5.2 are located with their lower edge preferably below the hub height N-VA of the front axle, would be possible if the tractor 1 did not have a continuous axle beam 13v, but rather a cranked axle or a single wheel suspension, and in between the at least one front battery module 5.2 could be mounted significantly lower than shown, which results in a more favorable center of gravity.

In FIG. 2a, b the battery holders 7.1, 7.2 required for fixing the battery modules 5 in the chassis 2 are shown in two different designs:

The battery holder 7.2 for the at least one front battery module 5.2 arranged on edge is U-shaped or L-shaped with upwardly pointing free-ending legs between which just the battery module 5.2 can be accommodated.

The battery holder 7.1 for the rear battery module 5.1 arranged on edge behind the rear axle consists basically of a support plate which is fastened to the upper side of the battery module 5.1 on the one hand and to the chassis 2 on the other hand, so that it is a primarily suspended fastening of the battery module 5.1, which is additionally fastened to fix the lower end of the battery module 5.1 relative to the chassis, but its weight is primarily supported in a suspended manner by the chassis.

In FIG. 5a, b, the battery holders 7.1, 7.2 required for fixing the battery modules 5 in the chassis 2 are also shown in two different designs:

There, they are U-shaped in both cases with freely ending legs pointing upwards, between which a battery module can be accommodated.

The spacing of the battery holders 7.1 is dimensioned so that a battery module, here 5.2, fits exactly between them on edge. Outside the tractor 1, it is shown that the battery holder 7.2—in the dashed design—is dimensioned so that a battery module fits between them lying flat or also two lying flat on top of each other, which can be achieved by appropriate upward extensions of the freely ending legs.

However, the example of the battery holder 7.2 also shows that instead of being U-shaped, they can be angled and hence be adjustable to different accommodating widths, i.e. a battery module standing on edge or lying flat.

In both cases, the horizontally lower legs usually have a fastening device for fastening them relative to the chassis 2, for example a cross member of the chassis 2 running in the transverse direction 11.

These may be, for example, through-holes for the insertion of screw connections, wherein there are then preferably different hole patterns for the individual tractor models, in this case 1A and 1B, because the cross member will then also have screw connection openings in different positions, for the optional positioning of one of the optionally different types of battery holders 7.1, 7.2 or of the same battery holder in different transverse positions and/or also longitudinal positions in the chassis 2.

The fastening of the battery modules (5) to the chassis (2) can also include damping, for example in the form of rubber elements placed therebetween, similar to an engine bearing.

FIG. 6a to d show—in each case only in plan view and only for a single tractor model, a long cab, in a single size—further arrangements of at least two or even more front battery modules in addition to the rear battery module 5.1 arranged behind the rear axle.

In FIG. 6a, 6b, a first front battery module 5.2a is positioned lying flat in the rear part of the front part of the chassis front part, i.e. as close as possible to the driver's cab 9 and thus mostly completely behind the front axle position P-VA as viewed in plan view, preferably with the greatest longitudinal extent of the battery length LB pointing in the transverse direction 11 of the tractor 1.

As a result, as much free distance as possible from this battery module 5.2a to the front end of the chassis 2 is achieved.

It is therefore possible in most cases to arrange in front of this first battery module 5.2a:
either a second or even third front battery module 5.2b lying flat, either according to FIG. 6a
or on edge according to FIG. 6b,
   preferably in each case with the battery length LB in the longitudinal direction 10 of the tractor 1.

If the height is sufficient, two flat-lying ones as shown in FIG. 6a or two on edge ones as shown in FIG. 6b can be arranged at this position, which increases the total number of battery modules to four.

In the solution according to FIG. 6a the two flat battery modules 5.2a, b can also overlap in the longitudinal direction 10 when they can be positioned at a different height, above all when the one at the foremost position is only a single battery module 5.2b.

In the solution according to FIG. 6a the two flat battery modules 5.2a, b can also be arranged with their battery length LB in the longitudinal direction 10 or in the transverse direction 11.

Preferably, the foremost battery module 5.2b extends over the front axle position P-VA so that the rear 5.2a of the two can be entirely within the axle spacing when viewed in plan view, resulting in a favorable weight distribution.

If these are battery modules with liquid cooling, the battery modules 5.2b of these front battery modules 5.2 that are lying further forward are mounted to the front with the liquid connections, as a result of which short conduit paths to the coolers K arranged in the front of the chassis 2 are possible.

In FIG. 6c, 6d, a first front battery module 5.2a is positioned on edge in the rear part of the front part of the chassis, i.e. as close as possible to the driver's cab 9 and therefore mostly completely behind the front axle position P-VA as viewed in plan view, preferably with the greatest longitudinal extent of the battery length LB pointing in the transverse direction 11 of the tractor 1.

As a result, as much free distance as possible from this battery module 5.2a to the front end of the chassis 2 is achieved.

As a result, a fortiori, as described for FIG. 6a, b, in front of this first front battery module 5.2a:
either a second or even a third front battery module 5.2b can be arranged flat according to FIG. 6c
or on edge according to FIG. 6d
   preferably in each case with the battery length LB in the longitudinal direction 10 of the tractor 1.

If the height is sufficient, two flat-lying battery modules according to FIG. 6c or two on edge ones arranged according to FIG. 6d can also be arranged here at this position, which can increase the total number of battery modules to four.

FIG. 7a-c show three further embodiments of the invention, wherein in each case a tractor is shown in a simplified manner by the axles VA, HA and tires 4 in a perspective view. In all three exemplary embodiments, the rear battery module 5.1 is arranged lying on edge with its longest extension direction in the transverse direction 11 and preferably behind the rear axle position of the vehicle. At least one further battery module 5.2 is arranged in each of the exemplary embodiments in front of the rear-axle position, preferably in the region of the front-axle position. The exemplary embodiments differ in the arrangement of the front battery modules 5.2.

In the embodiment according to FIG. 7a, two front battery modules 5.2 are arranged lying flat above the front axle position parallel one above the other, with their longest extension side (battery length) in the longitudinal direction 10 of the vehicle.

In the embodiment according to FIG. 7b on the other hand, the two front battery modules 5.2 are arranged lying on edge above the front axle position and parallel to each other with their longest side of extension (battery length) arranged in the longitudinal direction 10 of the vehicle.

In the embodiment according to FIG. 7c, a single front battery module 5.2 is positioned lying on edge above the front axle position and with its longest side of extension (battery length) in the longitudinal direction 10 of the vehicle.

### LIST OF REFERENCE SIGNS

1 Tractor
2 Chassis
3 Traction motor
4 Wheel
5.1 Rear battery module
5.2 Front battery module
6 Electrical connection
7 Module holder
8 Front part of the chassis, front hood
9 Driver's cab
9a Windshield
10 Longitudinal direction of tractor
11 Horizontal transverse direction
12 Vertical
13 Axle beam
14 Chassis side part
15 Chassis transverse part
LB Battery length
AA Axle spacing
K Cooler
N-VA Hub height of front axle
N-HA Hub height of rear axle
R-VA Wheel height of front axle
R-HA Wheel height of rear axle
VA Front axle
HA Rear axle

1. A battery electric tractor (1), in particular for use on the airport apron or in the logistics sector, comprising:
a chassis (2) to which two axles (VA, HA) are fastened,
at least one electric traction motor (3),
at least two battery modules (5.1, 5.2),
characterized in that
at least one rear battery module (5.1) is arranged behind, in particular completely behind, the rear-axle position (P-HA), in particular on edge, and
at least one front battery module (5.2) is arranged in front, in particular completely in front, of the rear axle position (P-HA).
(In particular specific to long cabs:)

2. The tractor according to claim 1,
characterized in that
the tractor (1) is designed as a long cab and has a chassis front part which is at least 60 cm long in front of the windshield (9a) of the driver's cab (9), and/or
the battery modules (5.1, 5.2) are arranged such that the axle load distribution is between 30% and 50%, better between 35% and 45%, better between 38% and 42% on the front axle and/or between 50% and 70%, better between 55% and 65%, better between 58% and 62%, on the rear axle.

3. The tractor according to any of the preceding claims,
characterized in that
the electric traction motor (3) is arranged above the driven rear axle (HA), in particular the rear axle beam:
in particular, projects a maximum of 40 cm, better a maximum of 20 cm, better a maximum of 15 cm, better a maximum of 10 cm, a maximum of only 5 cm, better not at all rearward beyond the rear axle body in plan view,
in particular a reducing active connection is arranged between the motor output shaft and the driven rear axle, in particular its differential, in the direction of travel (10) in front of the rest of the rear axle beam,
in particular, the inverter is arranged within the axle spacing (AA) in its rear half.

4. The tractor according to any of the preceding claims,
wherein in particular the battery modules are cuboid with different extensions in their three edge directions,
characterized in that the rear battery module (5.1) is arranged lying on edge or standing on edge with its battery length (LB) or battery width extending in the transverse direction (11) of the tractor.

5. The tractor according to any of the preceding claims,
characterized in that
the at least one front battery module (5.2) is arranged extending in the tractor longitudinal direction (10) over one of the axle positions (P-VA, P-HA) of one of the axles, in particular extending over the front axle position (P-VA) within the chassis (2) and/or
the at least one front battery module (5.2) is arranged above the axis of rotation or the hub height (N-VA, NHA), in particular above a continuous or cranked axle beam (13) in the transverse direction (11), of the corresponding axle.
(Front: longitudinal installation:)

6. The tractor according to any of the preceding claims,
characterized in that
the front battery module (5.2) positioned above the front axle position (P-VA) is arranged with its greatest direction of extension, its battery length (LB), in the longitudinal direction of the tractor (10) or at a deviation of a maximum of 30°, better a maximum of 20°, better a maximum of 10° from the longitudinal direction of the tractor (10), or/and
at least one front battery module (5.2), in particular in the case of longitudinal installation, is located for at least 40%, preferably at least 50%, preferably at least 60% of its extension in the longitudinal direction (10), viewed in plan view, in the region between the axle positions (P-VA, P-HA), i.e. within the axle spacing (AA),
in particular, the rest of its extension in the longitudinal direction (10) is arranged upstream from the front axle position (P-VA).
(front 2 modules longitudinally, on edge or lying:)

7. The tractor according to any of the preceding claims,
characterized in that
at least two front battery modules (5.2), in particular parallel next to one another, are arranged with their greatest direction of extension (LB) extending in the longitudinal direction (10) of the tractor over one of the axle positions (P-VA, P-HA), in particular extending over the front axle position (P-VA) within the chassis (2), wherein the wheels (4) preferably have an independent wheel suspension on the corresponding axle, or the corresponding axle is designed as a cranked rigid axle,
in particular these at least two battery modules (5.2) are arranged on edge, in particular lying on edge, in the longitudinal direction (10),
in particular, these at least two battery modules (5.2) are arranged above the axis of rotation or the hub height (N-VA, NHA), in particular above an axial body (13) of the corresponding axle which is continuous in the transverse direction.

8. The tractor according to any of the preceding claims,
characterized in that
at least two front battery modules (5.2), in particular parallel to one another, are arranged extending in the longitudinal direction (10) of the tractor over one of the axle positions (P-VA, P-HA), in particular extending over the front axle position (P-VA) within the chassis (2),
in particular, these at least two battery modules (5.2) are arranged lying flat, in particular running with their greatest extension direction (LB) in the transverse direction (11),
in particular of these at least two battery modules (5.2), at least one is arranged above the axis of rotation or the hub height (N-VA, N-HA) of the corresponding axis.

9. The tractor according to any of the preceding claims,
characterized in that
at least two front battery modules (5.2) are arranged parallel one above the other, extending in particular over the front axle position (P-VA) within the chassis (2) in the longitudinal direction of the tractor (10),
in particular these at least two battery modules (5.2) are arranged lying flat and spaced apart one above the other, in particular with their greatest direction of extension (LB) running in the longitudinal direction (10),
in particular of these at least two battery modules (5.2), at least one is arranged with its lower edge above the rotation axis or the hub height (N-VA) of the front axle.
(Mixed:)

10. The tractor according to any of the preceding claims,
characterized in that, of at least two front battery modules (5.2),
the battery module (5.2a) located further to the rear is either arranged lying flat, in particular with its greatest direction of extension (LB) running in the transverse direction (11), or is arranged on edge, in particular with its greatest direction of extension (LB) running in the transverse direction (11),
the battery module (5.2b) located further to the front is either arranged on edge, in particular with its greatest direction of extension (LB) running in the longitudinal direction (10), or lying flat, in particular with its greatest direction of extension (LB) running in the longitudinal direction (10),
in particular above the axis of rotation or the hub height (N-VA) of the corresponding axle.
(Specifically for cabovers:)

11. The tractor according to any of the preceding claims,
characterized in that
at least one front battery module (5.2) is arranged between the axles, in particular lying partially under the driver's cab (9) and in front of the front axle (VA).

12. A modular system for producing a battery electric tractor (1), comprising:
a chassis (2) to which two axles (AV, HA) are fastened,
at least one electric traction motor (3),
at least one battery module (5.1),
in particular a tractor (1) according to any of the preceding claims, characterized in that the following are available as modular components:
at least one type of battery module (5),
at least one type of module holder (7.1),
at least one type of traction motor (3).

13. The modular system according to claim 12,
characterized in that the following are available as modular components:
a type of module holder (7.2) for fastening a battery module (5) only lying flat to the chassis (2),
a type of module holder (7.1) for fastening a battery module (5) only upright to the chassis (2) in particular lying upright, in particular standing or suspended.

14. The modular system according to any of the preceding modular system claims,
characterized in that the following are available as modular components:
a plurality of types of traction motors (3) which differ in particular with regard to their continuous power,
a plurality of types of front axles (VA) and/or rear axles (AA) which differ in particular with regard to their wheel spacing and/or their permissible axle load.

15. The modular system according to any of the preceding modular system claims,
characterized in that the following are available as modular components:
at least one, preferably a plurality of types, of chassis side parts (14) which differ in particular with regard to their axle spacing (AA) and/or
at least one, preferably several types of chassis cross members (15), which differ in particular with regard to their length in the transverse direction, i.e. with regard to the possible track width.
